(19) United States
(12) Patent Application Publication
(10) Pub. No.: US 2010/0208549 A1
(43) Pub. Date: Aug. 19, 2010

(54) Pitcher Lid with Spout Gate and Stirring Mechanism

(76) Inventor: George A.S. Kitson, Winnipeg (CA)

Correspondence Address: ADE & COMPANY INC., 2157 Henderson Highway, WINNIPEG, MB, R2G1P9, CA

(21) Appl. No.: 12/633,439

(22) Filed: Dec. 8, 2009

Related U.S. Application Data
(60) Provisional application No. 61/120,598, filed on Dec. 8, 2008.

(51) Int. Cl. B01F 7/00; B65D 25/40

(52) U.S. Cl. 366/247; 222/570

(57) ABSTRACT

A lid for a pitcher comprises an annular lid body arranged to be supported to span the open top end of the pitcher in which the lid body has a spout opening therein arranged to be aligned with the spout of the pitcher. A gate member is supported on the lid body so as to be arranged for movement relative to the lid body and the pitcher body in a circumferential direction between a closed position in which the gate member spans the spout opening in the lid body and an open position in which the spout opening is substantially unobstructed by the gate member.

This application claims the benefit under 35 U.S.C. 119(e) of U.S. provisional application Ser. No. 61/120,598, filed Dec. 8, 2009.

### FIELD OF THE INVENTION

The present invention relates to a lid for a pitcher for dispensing a liquid therefrom, and more particularly relates to a pitcher lid having a spout gate movable relative to the pitcher between open and closed positions and to a pitcher lid having a stirring mechanism arranged for stirring a liquid within the pitcher.

### BACKGROUND

It is known to be desirable to mix juice within containers where the juice is stored so that denser particles which settle to the bottom of the container can be more evenly mixed throughout the liquid prior to dispensing. Various examples of juice containers which permit mixing of the contents therein are known in the prior art. It is also desirable to enclose the dispensing spout of the container when stored to prevent the juice from mixing with other flavours in a refrigerator for example or to prevent accidental spillage.

U.S. Pat. No. 6,086,240 discloses a pitcher including a mixing blade supported from the lid of the container which reciprocates by pivoting about a horizontal axis by a user which grasps a handle extending upwardly from the lid. The large protruding handle is awkward for storage, while the reciprocating horizontal movement is awkward for users to manipulate the mixing blade. In order to enclose the dispensing aperture of the container, a hinged flap covers the opening. The configuration of the hinge flap however interferes somewhat with pouring when dispensing.

Canadian patent 2,247,212 discloses a mixing pitcher in which a plunger is vertically displaced through the container for mixing. A very long vertical stroke movement is required to adequately mix the full contents of the container. Closing the opening of the spout of the container requires fully rotating the lid relative to the pitcher requiring an awkward movement of both hands of the user to grasp the pitcher and the lid separately to close the opening.

U.S. Pat. No. 5,407,270 discloses a stirring pitcher in which a mixing blade within the container is coupled to a handle on the lid for rotation together about a common vertical axis. The stirring motion is more compact, however the configuration of the handle still protrudes upwardly from the lid so as to be awkward for storage. Furthermore the blade comprises radially extending paddles which only serve to stir the liquid in the container in a circumferential direction so that limited up and down mixing of the contents is provided. Closing the dispensing opening also requires an awkward manipulation using both hands of the user to rotate the lid relative to the pitcher.

### SUMMARY OF THE INVENTION

According to one aspect of the invention there is provided a lid for a pitcher having pitcher body comprising a base, a generally cylindrical wall extending upwardly from the base to a peripheral edge extending about an open top end of the pitcher, and a spout formed in the wall adjacent the open top end of the pitcher, the lid comprising:

a lid body arranged to be supported on the pitcher body to span the open top end of the pitcher, the lid body having a spout opening therein arranged to be aligned with the spout in the wall of the pitcher body;

a gate member supported on the lid body so as to be arranged for movement relative to the lid body and the pitcher body between a closed position in which the gate member spans the spout opening in the lid body and an open position in which the spout opening is substantially unobstructed by the gate member.

By providing a gate which is moveable relative to the lid body a more simplified gate structure is provided which can be operated by the same hand holding the pitcher to simplify the opening and closing action of the dispensing opening of the pitcher. More particularly, use of a gate handle which is movable with the gate member and which is located adjacent the pitcher handle diametrically opposite the spout and gate member allows a single hand of the user which grasps the handle on the pitcher to operate the gate member with their thumb as the lid body remains fixed relative to the pitcher body during opening and closing of the gate member. The sliding gate configuration described herein also permits the dispensing opening to be fully unobstructed in the open position while providing an adequate seal to span the opening in the closed position.

Preferably the gate member is moveable in a circumferential direction between the open and closed positions so as to be arranged for movement about the peripheral edge about the open top end of the pitcher.

When the lid body comprises a generally cylindrical outer wall, preferably the gate member is supported adjacent an inner surface of the outer wall of the lid body so as to be moveable between the open and closed positions in a circumferential direction along the inner surface of the outer wall.

There may be provided a gate handle supported on a top side of the lid body in which the gate handle is coupled to the gate member within an interior of the lid body through a slot in the top side of the lid body such that the gate member and the gate handle are moveable together between the open position and the closed position.

The gate member may comprise a gate opening arranged to be aligned with the spout opening in the open position of the gate member.

Preferably the gate handle is circumferentially spaced from the gate opening such that the gate handle and the gate opening are substantially diametrically opposite one another so as to be arranged to be supported at opposing sides of the open top end of the pitcher.

Preferably the gate member and the gate handle are substantially wholly contained within a boundary of the lid body in the circumferential direction and are substantially wholly contained in height below a top end of the lid body.

The gate handle may be moveable relative to the lid body between an open indicator and a closed indicator on the lid body as the gate member is displaced between the open position and the closed position respectively.

The lid body may comprise a generally cylindrical outer wall and the gate member may comprise an annular member supported along an inner surface of the outer wall about a full circumference of the lid body so as to be moveable between the open and closed positions in a circumferential direction along the inner surface of the outer wall.

The cylindrical wall of the pitcher body preferably includes a lower portion having a first interior diameter and an upper portion above the lower portion having a second interior diameter greater than the first interior diameter in which the lid body is received in the upper portion of the pitcher body.

There may be provided a stirring mechanism comprising a stir handle supported at a top side of the lid body for rotation about a central upright axis and a mixing blade extending downwardly below the lid member so as to be arranged to extend downwardly into the pitcher body in which the stir handle and the mixing blade are coupled for rotation together about the upright axis relative to the lid body. When the lid body comprise an upper rim portion about a periphery of the lid body and a recessed central portion which is recessed in relation to the surrounding rim portion, the stir handle is preferably located in the recessed central portion and includes a gripping portion located radially outward from the upright axis and arranged to be gripped by a user. Preferably the gripping portion is fully received below a height of the rim portion of the lid body and comprises a socket arranged to receive a single finger of a user therein.

The mixing blade may comprise a plate like member which is twisted about the upright axis and which increases in radial distance from the upright axis with increasing distance in an axial direction from the lid body.

Preferably the lid body and the pitcher are arranged for interlocking connection so as to be arranged to resist relative rotation about an upright axis therebetween.

When the spout protrudes outwardly from the wall of the pitcher body, preferably the lid body comprises a pair of depending portions arranged to extend downwardly along an outer side of the wall of the pitcher body adjacent opposing sides of the spout.

When the lid body comprises a cylindrical outer wall, the gate member may comprise an annular member spanning a full height of the cylindrical outer wall about a full circumference of the lid body.

When the lid body further comprises a top wall including a rim portion about a periphery of the lid body and a recessed central portion which is spaced inwardly from the outer wall of the lid body and which is recessed in relation to the rim portion, the gate member preferably comprises a flange portion extending inwardly from a top end of the annular member so as to be arranged to span the rim portion of the lid body in a radial direction between the outer wall and the recessed central portion. The gate handle is preferably supported on the flange portion of the gate member to extend upwardly through a slot in the rim portion of the lid body.

According to a second aspect of the present invention there is provided a lid for a pitcher having pitcher body comprising a base, a generally cylindrical wall extending upwardly from the base to a peripheral edge extending about an open top end of the pitcher, the lid comprising:

a lid body arranged to be supported on the pitcher body to span the open top end of the pitcher;

the lid body comprising an upper rim portion about a periphery of the lid body and a recessed central portion which is recessed in relation to the surrounding rim portion;

a stirring mechanism comprising a stir handle supported at a top side of the lid for rotation about a central upright axis and a mixing blade extending downwardly below the lid member so as to be arranged to extend downwardly into the pitcher body;

the stir handle and the mixing blade being coupled for rotation together about the upright axis relative to the lid body;

the stir handle locating a gripping portion therein at a location spaced radially outward from the upright axis;

the gripping portion being arranged to be gripped by a user to rotate the stir handle; and

the gripping portion being fully received below a height of the rim portion of the lid body.

The configuration of the stir handle described herein in which the handle is recessed relative to the lid body provides a compact configuration which occupies minimal space when stored.

Some embodiments of the invention will now be described in conjunction with the accompanying drawings in which:

### BRIEF DESCRIPTION OF THE DRAWINGS

FIG. 1 is a perspective view of a first embodiment of the lid supported on a pitcher.

FIG. 2 is a sectional view along the line 2-2 of FIG. 1.

FIG. 3 is a perspective view of the stirring mechanism shown separated from the lid of FIG. 1.

FIG. 4 is an elevational view of the stirring mechanism shown supported on the lid of FIG. 1 in which the lid is shown in cross-section.

FIG. 5 is a perspective view of the lid of FIG. 1 shown separate from the pitcher and the stirring mechanism.

FIG. 6 is a perspective view of the gate member and gate handle according to FIG. 5 shown separated from the lid body.

FIG. 7 is a perspective view of a second embodiment of the lid and pitcher.

FIG. 8 is a perspective view of the lid body of the lid of FIG. 7 shown separated from the pitcher and the gate member.

FIG. 9 is a perspective view of the gate member for use with the lid of FIG. 7.

FIG. 10 is a perspective view of the gate member supported on the lid body of the lid according to FIG. 7.

FIG. 11 is an exploded perspective view of the stirring mechanism including the stir handle and mixing blade shown separated from the lid body and separated from one another.

In the drawings like characters of reference indicate corresponding parts in the different figures.

### DETAILED DESCRIPTION

Referring to the accompanying figures there is illustrated a pitcher lid generally indicated by reference numeral 10. Although various embodiments are described and illustrated herein, some of the common features will first be described.

The lid 10 is particularly suited for a pitcher 12 of the type commonly used for dispensing juice therefrom. More particularly the pitcher 12 comprises a base wall 14 which is generally horizontal and circular at the bottom end thereof. A cylindrical wall 16 extends generally vertically upward from a periphery of the base wall 14 to a top peripheral edge 18 extending about an open top end of the pitcher. The base wall and cylindrical wall are joined so as to be suitable for containing a fluid within the interior of the pitcher.

The pitcher further includes a handle 20 comprising a generally vertically extending member which is spaced radially outward from the cylindrical wall 16. The handle 20 is joined to the wall adjacent the top end thereof.

A spout 22 is formed in the cylindrical wall 16 adjacent the top end thereof at a location which is diametrically opposite the handle 20. The spout 22 comprises a protruding portion of the cylindrical wall in alignment with a gap in the top peripheral edge 18 of the cylindrical wall to assist in pouring contents from the pitcher.

The cylindrical wall 16 includes a lower portion 24 having a first interior diameter which gradually increases slightly from the bottom end to the top end thereof. The cylindrical wall also includes an upper portion 26 which is stepped outwardly in relation to the lower portion so as to have a greater interior diameter than the top end of the lower portion 24. A horizontal shoulder is formed at the intersection of the lower portion 24 and the upper portion 26.

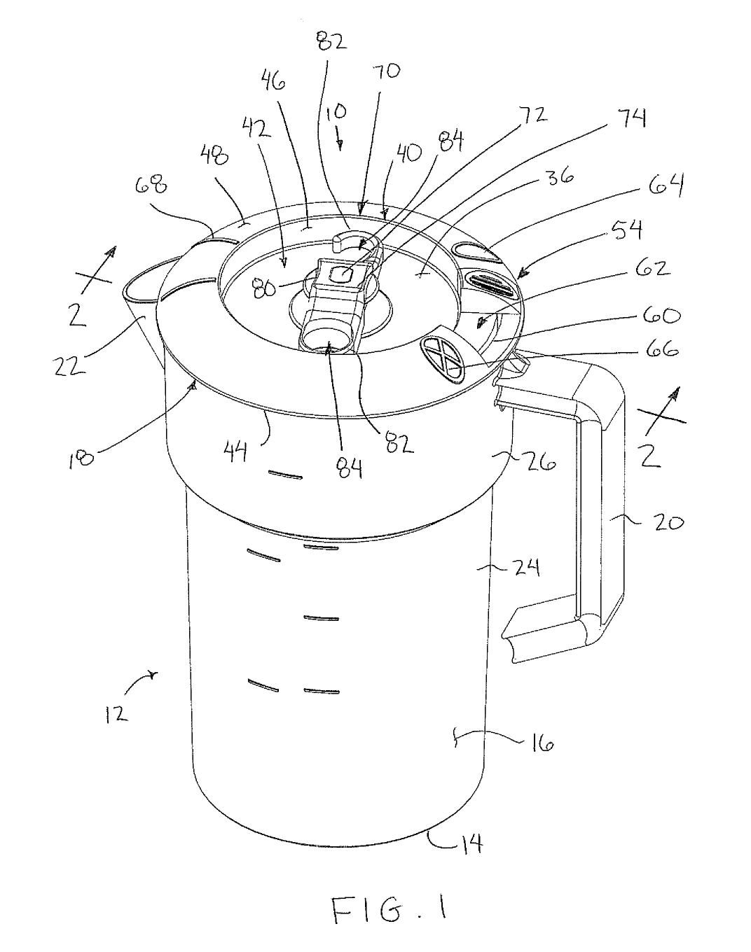

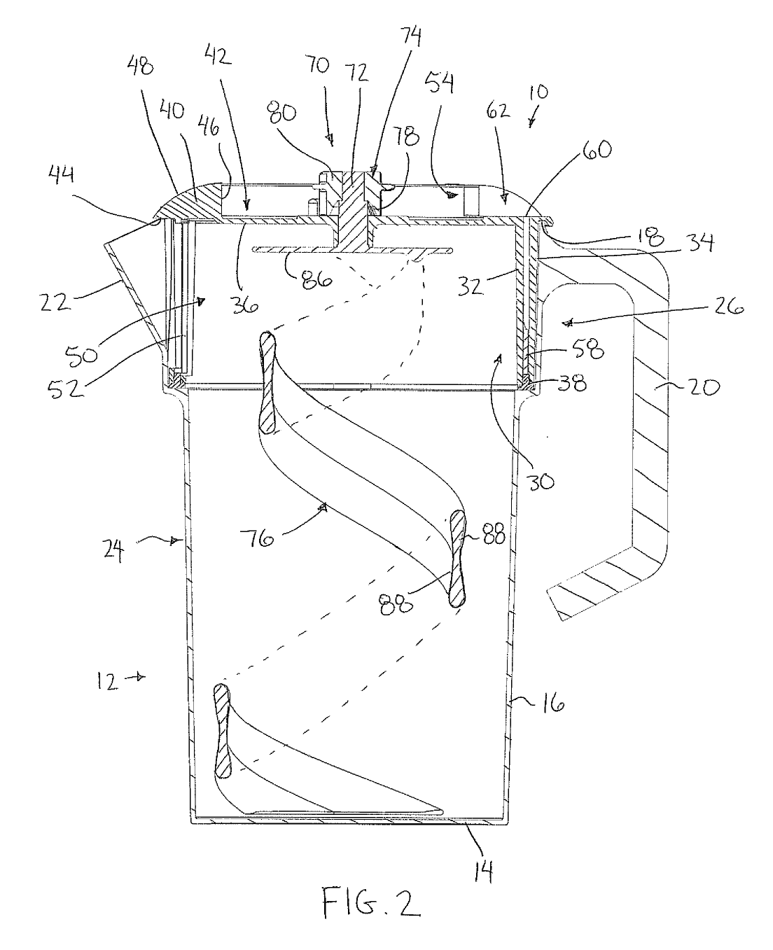

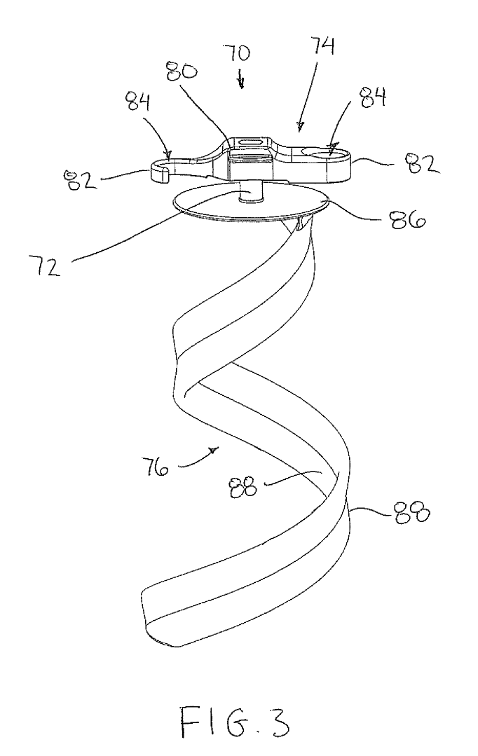

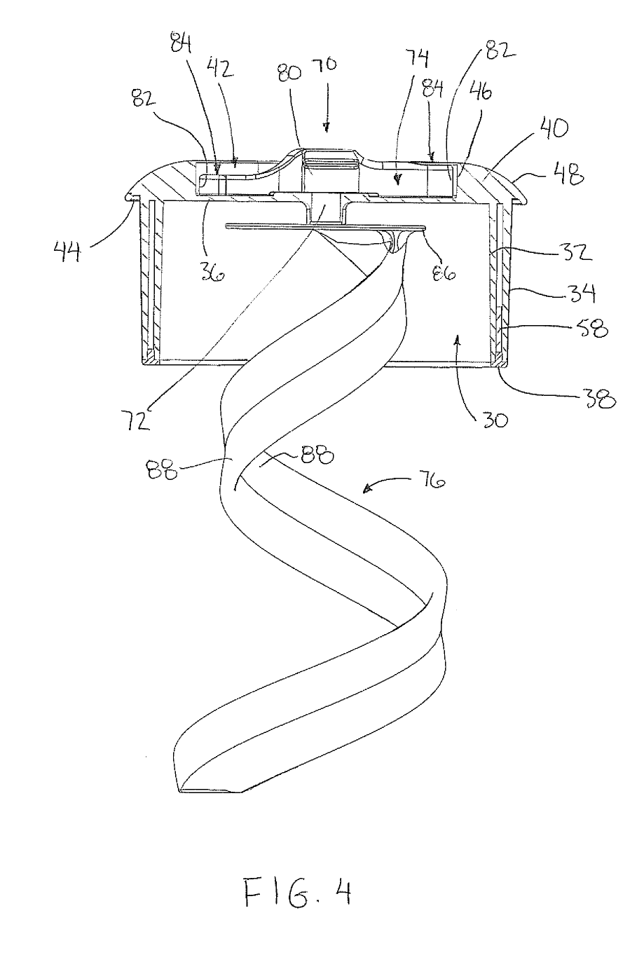

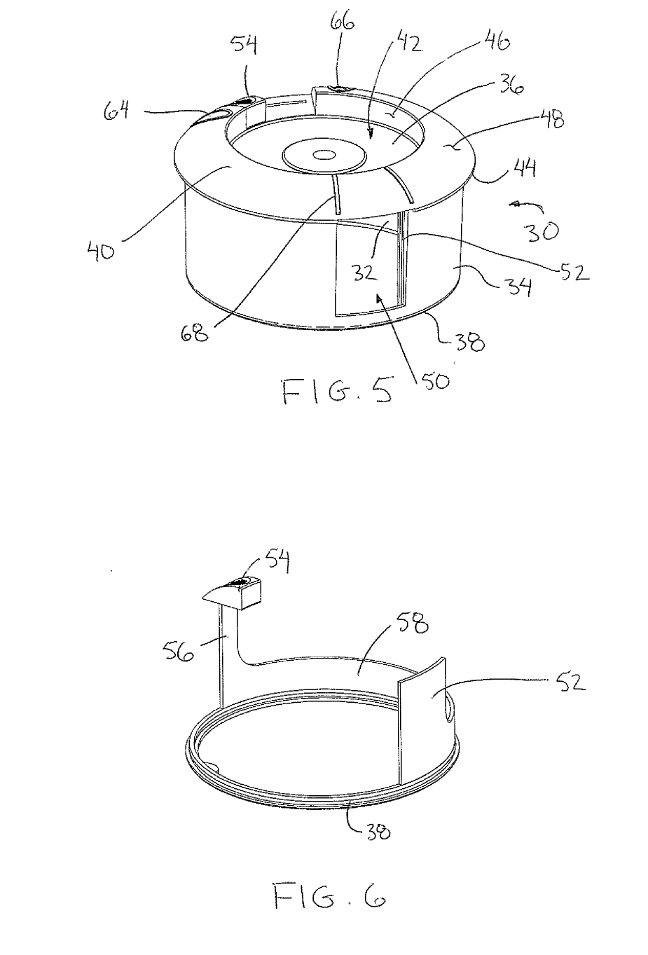

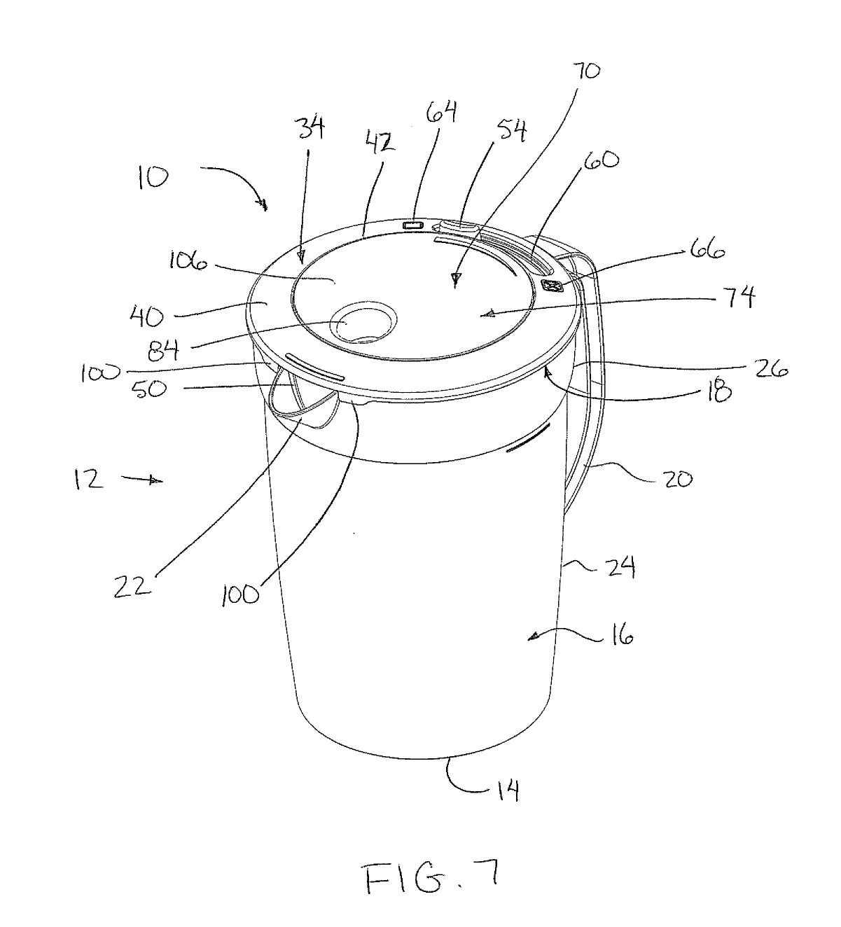

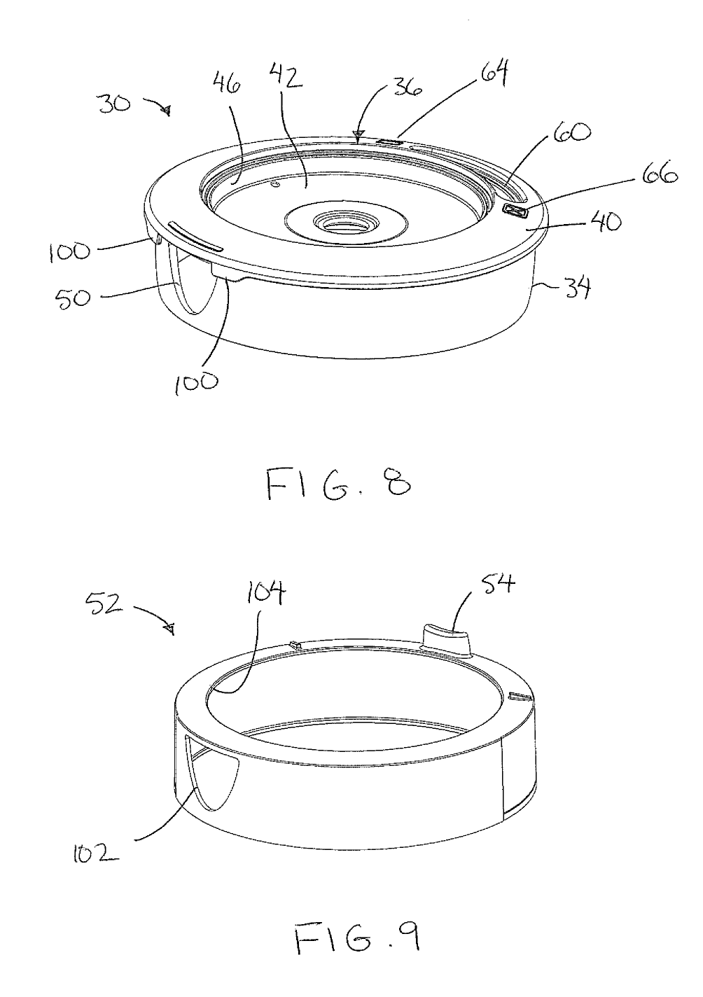

Turning to the first embodiment of FIGS. 1 through 6, the lid comprises a lid body 30 having an inner cylindrical wall 32 and an outer cylindrical wall 34. The inner cylindrical wall 32 is concentric with the outer cylindrical wall and spaced inward therefrom so that the walls are substantially parallel with one another and spaced apart to define an annular gap therebetween. The overall thickness of the inner and outer walls together with the gap therebetween in the radial direction is approximately equal to the difference in interior diameter between the upper and lower portions of the wall of the pitcher body at the shoulder with the outer cylindrical wall fitting closely within the interior diameter of the upper portion 26 of the pitcher such that the inner diameter of the inner cylindrical wall 32 is approximately equal to the inner diameter of the lower pitcher adjacent the top end thereof. Accordingly the inside surface of the wall of the lid is substantially flush with the inside surface of the cylindrical wall of the pitcher when the lid is supported on the body of the pitcher.

The inner and outer walls 32 and 34 of the lid body are joined with one another at the top end thereof by a top wall 36 of the lid. The top wall spans generally horizontally across the top end of the lid body so as to be arranged to enclose and span across the open top end of the pitcher body when the lid is mounted on the pitcher body.

A sealing member 38 is arranged to be received within the annular gap between the inner and outer walls of the lid body adjacent the bottom end thereof for enclosing an annular opening in the bottom of the lid body which is open to the annular gap between the walls. The sealing member 38 has a cross sectional T-shape so that the sealing member includes a stem portion which extends upwardly into the annular gap and a perpendicular base portion joined to the stem portion which spans generally horizontally across the width of the inner and outer walls to overlap the bottom end of both walls about the full circumference of the lid.

The lid body further comprises a peripheral rim portion 40 which is raised in height relative to a central recessed portion 42. The central recessed portion 42 comprises a thin horizontal wall spanning across between the top ends of the inner and outer walls of the lid body. The rim portion 40 extends about the periphery of the central portion and extends radially outward beyond the periphery of the outer wall of the lid body to define an overlapped portion which extends overtop in overlapping configuration with the top peripheral edge of the wall of the pitcher body. A groove is formed in the underside of the overlap portion 44 which receives the top edge of the wall therein so that the rim portion also overlaps partially overtop of the outer surface of the wall of the pitcher adjacent the top edge thereof. A height of the inner and outer walls is arranged to be approximately equal to a height of the upper portion of the walls of the pitcher such that the overlapped portion 44 engages the top peripheral edge of the wall of the pitcher when the bottom end locating the sealing member 38 therein of the inner and outer walls are engaged upon the horizontal shoulder surface between the upper and lower portions of the pitcher walls.

The peripheral rim portion 40 includes a generally vertical inner wall 46 extending substantially vertically upward from the periphery of the central portion 42 of the lid to the top end of the lid where the vertical inner wall 46 meets with a sloped outer wall 48 which slopes downwardly and radially outward from the top edge of the vertical inner wall to the outer peripheral edge of the overlapped portion 44.

A dispensing opening 50 is located in each of the inner and outer walls of the lid body in alignment with one another and being arranged to be suitably sized and located for alignment with the spout 22 formed in the wall of the pitcher. A bottom edge of the opening in the inner wall of the lid body is generally horizontal and at a location below a height of the stem portion of the sealing member extending upwardly into the annular space so that any fluid which might leak into the space between the inner and outer walls of the lid body is contained above the sealing member and communicates with the dispensing opening 50 in the inner wall of the lid body to be permitted to drain back down and inwardly into the hollow interior of the pitcher.

A gate member 52 is provided for selectively spanning across the dispensing opening 50 in the lid body in a closed position. The gate member 52 comprises a panel having a curvature which matches the curvature of the cylindrical inner and outer walls so as to be slidable within the annular gap in the circumferential direction about the central upright access of the cylindrical lid body and pitcher. The gate member 52 is arranged to be slidably inserted and removed for cleaning by removal of the sealing member and subsequent sliding of the gate member through the resulting open bottom end of the lid body between the inner and outer cylindrical walls thereof.

The gate member is slidably displaced between an open position in which the panel of the gate member is circumferentially offset from the dispensing openings 50 so that the openings are substantially unobstructed and a closed position in which the panel of the gate member spans fully across the openings to enclose the openings and prevent dispensing of fluid therethrough.

The gate member is moveable between open and closed positions by a gate handle 54 supported on a gate handle post 56 which is in turn connected integrally with the gate member 52 by a connecting member 58 extending circumferentially therebetween. The gate handle 54 and gate handle post 56 upon which it is supported are located diametrically opposite from the gate member so as to be circumferentially spaced therefrom. The gate member 52 is thus arranged to be operatively supported in proximity to the spout of the pitcher while the gate handle is supported adjacent the diametrically opposite handle of the pitcher. The connecting member 58 comprises a flat member integrally formed with the panel of the gate member which is curved to extend within the annular gap between the inner and outer walls of the lid body from the gate member to the gate handle post. The gate handle post 56 extends generally vertically upward from the connecting member 58 within the annular space between the inner and outer walls to extend upwardly through a slot 60 formed in the top wall of the lid body. In this manner the gate handle post 56 communicates between the connecting member 58 received internally within the annular space between the inner and outer walls through the slot to the gate handle 54 which is supported externally on the top side of the lid body.

The rim portion 40 of the lid body includes a suitable gap 62 formed therein which extends partway about a circumference of the lid in which the height of the lid body at the peripheral edge is near a height of the central recessed portion 42 of the lid so as to be reduced in height relative to the remainder of the peripheral rim portion 40. The slot 60 through which the gate handle post 56 communicates is located within the gap 62 of the rim portion so that gate handle 54 can also be located within the gap of the rim portion for movement in the circumferential direction together with the gate member and the connecting member therebetween in the circumferential direction between the open and closed positions of the gate member. The gate handle 54 is arranged to the have the same cross sectional shape as the rim portion 40 so that the gate handle 54 similarly comprises a vertical inner wall arranged for flush alignment with the inner wall 46 of the rim portion and a sloped outer wall which is curved downwardly and radially outward from the top edge of the vertical inner wall to be substantially flush with the outer wall 48 of the rim portion at the top side of the lid body.

An open indicator 64 and a closed indicator 66 are located on the rim portion of the lid body at opposing ends of the gap 62 in the rim portion so that the gate handle 54 is moveable in the circumferential direction between the open indicator and the closed indicator as the gate member is moveable therewith between the open position and the closed position respectively thereof relative to the spout. Spout indicators 68 are provided at the diametrically opposed side of the rim portion 40 of the lid body for alignment with the spout to ensure that the openings 50 in the inner and outer walls of the lid body are suitably aligned with the spout.

The gate member, gate handle and connecting members therebetween are all arranged to be fully contained within the circumferential boundary of the outer periphery of the lid body as well as being wholly and fully contained below a top boundary of the rim portion so that no portion of the gate or gate handle protrudes beyond the perimeter of the lid body.

The lid 10 further comprises a stir mechanism 70 which permits the contents of the pitcher to be uniformly mixed. The stir mechanism comprises a central post 72 rotatably received through a corresponding central aperture in the top wall of the lid body. At a top end of the post 72 the post is connected to a stir handle 74 supported externally on the top side of the lid within the recessed central portion of the lid body. At the bottom end, the post 72 is connected to a suitable mixing blade 76 which is arranged for mixing the contents of the pitcher uniformly. The mixing blade and the stir handle are coupled together through the post 72 for rotating the movement together about the upright central vertical axis of the cylindrical lid and pitcher. A flange 78 is provided on the post 72 adjacent the upper side of the top wall of the lid body which serves to suspend the mixing blade from the lid body to extend downwardly into the interior of the pitcher body.

The stir handle 74 comprises a central portion 80 which serves to connect in a non-rotatably mating configuration with the top end of the post 72. The stir handle extends radially outward from the central portion 80 in two diametrically opposed radial directions towards two opposed free ends 82 of the handles. Each free end 82 locates a gripping portion 84 therein which is suitable for receiving a single finger of an operator therein to grip the handle and rotate the handle about the central axis thereof. Both free ends of the handle including the gripping portions 84 thereof are arranged to be fully contained within the circumferential boundary of the recessed portion of the lid body as well as being wholly contained and recessed within a height boundary of the lid body defined by the surrounding peripheral rim portion 40.

As illustrated, one of the gripping portions 84 comprises a socket which is open only at the top side thereof to receive a single finger inserted therein to permit a user to rotate the stir handle in either one of two opposed directions of rotation about the central upright axis. The other gripping portion 84 comprises a hook which is open to one side thereof and which is also suitably sized to receive a single finger of a user therein so that hook is well-oriented to rotate the stir handle in a first direction of rotation however attempts to rotate in the opposing direction permits the user's finger to be released from the gripping portion through the open side of the hook.

The mixing blade 76 is joined to the bottom end of the post by a mounting plate 86 which is generally horizontal and circular to extend radially outward from the post directly below the top wall of the lid body spaced up above the bottom end of the inner and outer walls of the lid body. The mixing blade is mounted adjacent the outer periphery of the mounting plate 86 at the bottom side thereof to extend downward and inwardly into the hollow interior of the pitcher body.

The mixing blade comprises an elongate ribbon like member which follows a generally helical path about the central axis of rotation thereof. The elongate member spans a full height of the interior of the pitcher body so that a bottom end of the mixing blade is located directly adjacent the base wall of the pitcher body. The elongate member forming the mixing blade follows the helical path downwardly into pitcher body with gradually increasing radial distance from the central axis of rotation thereof which increasing distance in the axial direction from the lid body as the blade approaches the base wall of the pitcher body.

The elongate member forming the mixing blade has an elongate and upright cross section forming two opposed upright faces 88 which are parallel and in close proximity to one another in an upright orientation so as to be generally parallel to the axis of rotation. The faces 88 include an inner face facing radially inward to the axis and an outer face facing radially outward to the cylindrical wall of the surrounding pitcher body. The top end of the elongate member forming the mixing blade is joined to the mounting plate 86 at a location spaced radially outward from the axis of rotation and the space from the axis of rotation increases towards the bottom end of the blade member which is nearer to the outer cylindrical wall of the surrounding pitcher body than the top end.

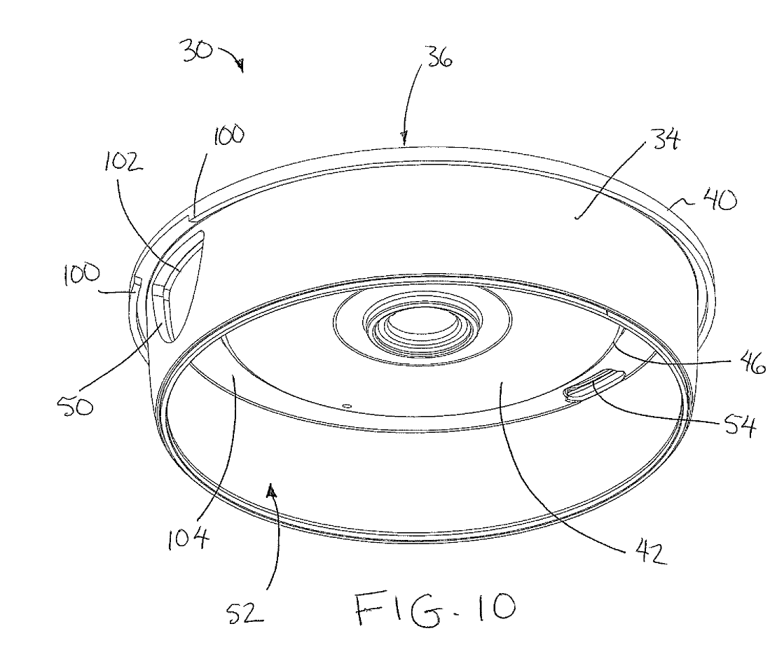

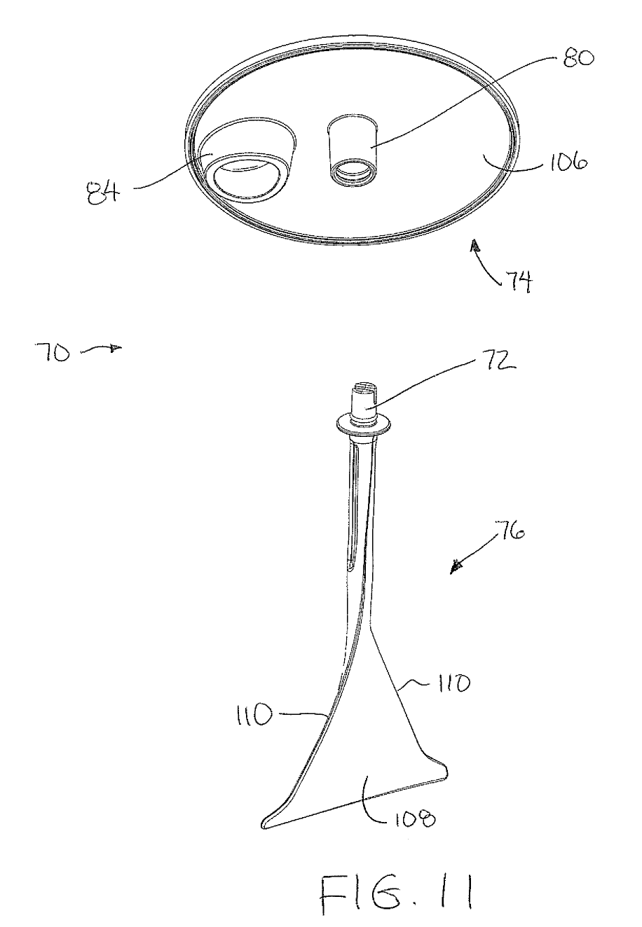

Turning now to the second embodiment of FIGS. 7 through 11, the lid similarly comprises a lid body 30 and a gate member 52 operable between open and closed positions in relation to the lid body. The lid according to the second embodiment is substantially identical to the previous embodiment with regard to the lid body 30 received in the upper portion 26 of the pitcher and which supports the gate member 52 therein. The lid body 30 also similarly comprises an outer cylindrical wall 34 which closely fits within the diameter and height of the upper portion of the pitcher and which is enclosed at a top end by a top wall 36. The outer cylindrical wall 34 also includes a dispending opening 50 therein which is arranged for alignment with the spout opening in the pitcher. The rim portion 40 of the top wall in the second embodiment overlaps the top edge of the pitcher and is again raised in relation to a central recessed portion 42 which is circular and recessed in height relation to the rim portion by a vertical wall 46 spanning there between and which is spaced radially inwardly in relation to the outer wall.

As in the previous embodiment the gate member 52 is supported along the inner surface of the outer wall for sliding movement in relation thereto in a circumferential direction between a closed position in which the gate member spans the spout opening in the lid body and an open position in which the spout opening is substantially unobstructed by the gate member. The gate member 52 also comprises a gate handle 54 which is integrally formed with the gate member for movement in a circumferential direction relative to the lid body between the open and closed positions. The gate handle is arranged to be positioned approximately diametrically opposite the dispensing opening 50 of the lid body so as to be positioned close to the handle of the pitcher. The gate handle 54 extends upwardly through an arcuate slot 60 in the rim portion of the lid body so that the height of the handle is near the height of the rim portion so as to be slightly recessed in relation to the rim portion as in the previous embodiment. An open indicator 64 and a closed indicator 66 can also be provided on the rim portion in a similar manner to the previous embodiment.

The second embodiment also similarly comprises a stir mechanism including a central post 72 extending upward through a central opening in the top wall for connection between a stir handle 74 on top of the top wall 36 of the lid body and a mixing blade 76 on the bottom side of the lid body for extending downwardly into the pitcher. A central portion 80 of the stir handle 74 locates a socket therein into which the post at the top end of the mounting blade is inserted in interlocking connection in the finished assembly of the lid. The gripping portion 84 in the second embodiment similarly comprises a recess suitable for receiving the tip of a finger of the user therein at a location spaced radially outward from the central axis of the stir mechanism.

The second embodiment is distinguished from the first embodiment in that the lid body further comprises a pair of depending portions 100 supported on the outer periphery of the rim portion to depend downwardly over the outer side of the cylindrical wall of the pitcher. In the illustrated embodiment two depending portions 100 are provided at opposing sides of the dispensing opening 50 in the outer wall of the lid body so as to be arranged for engagement with opposing sides of the spout received therebetween when the dispensing opening 50 is aligned with the spout opening in the pitcher. The depending portions 100 serve to mount the lid body in interlocking engagement with the pitcher to prevent relative rotation therebetween about a vertical axis of the pitcher.

The second embodiment is further distinguished from the previous embodiment in that the lid body only comprises the outer cylindrical wall 34 with no additional inner wall being provided so that the gate member is supported along the inner surface of the lid body. The gate member 52 in this instance comprises a cylindrical upright wall which extends about the full circumference of the lid body with an outer diameter corresponding approximately to the inner diameter of the lid body for being slidably received therein. The overall lid assembly including the outer cylindrical wall 34 of the lid body and the gate member along the inner surface thereof thus have a smaller thickness in the radial direction than the previous embodiment so that the shoulder formed in the pitcher wall between the upper and lower portions thereof can be reduced in relation to the previous embodiment.

The gate member 52 of the second embodiment is further distinguished in locating a gate opening 102 therein which is substantially identical in shape and size to the dispensing opening in the outer cylindrical wall and the spout opening in the pitcher for alignment therewith in the open position of the gate. Slidably displacing the gate member in the circumferential direction displaces the gate member into the closed position so that the gate opening and the dispensing opening are not aligned and the gate member accordingly spans the dispensing opening in the lid body and the spout. The inner surface of the gate member comprises a continuous cylindrical surface; however, the outer surface of the gate member is reduced in thickness in relation to a bottom rim portion and a working portion spanning a portion of the circumference in working relation with the dispensing opening between the open and closed positions of the spout. In this manner, the material used in forming the gate member is reduced while also minimizing the frictional contact of the gate member with the inner surface of the outer cylindrical wall to a minimum lower peripheral rim about most of the circumference thereof.

The gate member 52 of the second embodiment further comprises a flange portion 104 which extends radially inward from the top edge of the cylindrical collar defining the primary portion of the gate member. The flange portion 104 has a radial dimension corresponding approximately to the dimension of the rimmed portion of the top wall of the lid body so that the flange portion is arranged to span horizontally inward from the gate member adjacent the outer wall of the lid body to an inner free edge located directly adjacent the vertical inner wall 46 of the lid body which supports the central recessed portion 42. The flange portion 104 supports the gate handle 54 on a top side thereof to extend upward through the slot 60 in the rim portion of the lid body.

The stir handle 74 of the second embodiment comprises a circular plate 106 arranged to fully span the central recessed portion 42 of the lid body so as to be substantially flush with the rim portion of the lid body at the top side thereof. The central portion 80 in this instance comprises a socket depending from the centre of the circular plate 106 to engage the top side of the central recessed portion about the central aperture receiving the post 72 of the mixing blade upwardly there through.

The circular plate 106 locates a single gripping portion 84 therein adjacent to the periphery of the circular plate and central recessed portion within which it is received so as to be spaced radially outward from the central vertical access of rotation.

The mixing blade 76 according to the second embodiment extends vertically downward along the axis of rotation towards a bottom end arranged to be positioned close to the bottom wall of the pitcher. The blade in this instance comprises a plate-like member 108 spanning between two opposing edges 110 which diverge from one another with increasing distance from the central axis of rotation from the top end towards the bottom end of the mixing blade where the blade is widest in a radial dimension. The plate is twisted about the vertical access to function somewhat as a screw for churning the contents of the pitcher when rotated.

Use of the second embodiment is substantially identical to the first embodiment in that a user grasps the handle of the pitcher in their hand so that the thumb of the user can be position on the gate handle for controlling movement of the gate handle and the gate member connected thereto between the open and closed positions thereof. When it is desired to mix the contents of the pitcher, placement of a single finger in the gripping portion 84 and rotation thereof about the central axis of the stirring mechanism causes the blade to churn the contents of the pitcher.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A lid for a pitcher having pitcher body comprising a base, a generally cylindrical wall extending upwardly from the base to a peripheral edge extending about an open top end of the pitcher, and a spout formed in the wall adjacent the open top end of the pitcher, the lid comprising:
a lid body arranged to be supported on the pitcher body to span the open top end of the pitcher, the lid body having a spout opening therein arranged to be aligned with the spout in the wall of the pitcher body;
a gate member supported on the lid body so as to be arranged for movement relative to the lid body and the pitcher body between a closed position in which the gate member spans the spout opening in the lid body and an open position in which the spout opening is substantially unobstructed by the gate member.

2. The lid according to claim 1 wherein the gate member is moveable in a circumferential direction between the open and closed positions so as to be arranged for movement about the peripheral edge about the open top end of the pitcher.

3. The lid according to claim 1 wherein the lid body comprises a generally cylindrical outer wall and the gate member is supported adjacent an inner surface of the outer wall of the lid body so as to be moveable between the open and closed positions in a circumferential direction along the inner surface of the outer wall.

4. The lid according to claim 1 wherein there is provided a gate handle supported on a top side of the lid body, the gate handle being coupled to the gate member within an interior of the lid body through a slot in the top side of the lid body such that the gate member and the gate handle are moveable together between the open position and the closed position.

5. The lid according to claim 1 wherein the gate member comprises a gate opening arranged to be aligned with the spout opening in the open position of the gate member.

6. The lid according to claim 5 wherein there is provided a gate handle supported on a top side of the lid body, the gate handle being coupled to the gate member within an interior of the lid body through a slot in the top side of the lid body such that the gate member and the gate handle are moveable together between the open position and the closed position, and wherein the gate handle is circumferentially spaced from the gate opening.

7. The lid according to claim 6 wherein the gate handle and the gate opening are substantially diametrically opposite one another so as to be arranged to be supported at opposing sides of the open top end of the pitcher.

8. The lid according to claim 1 wherein there is provided a gate handle supported on a top side of the lid body, the gate handle being coupled to the gate member within an interior of the lid body through a slot in the top side of the lid body such that the gate member and the gate handle are moveable together between the open position and the closed position, and wherein the gate member and the gate handle are substantially wholly contained within a boundary of the lid body in the circumferential direction and are substantially wholly contained in height below a top end of the lid body.

9. The lid according to claim 1 wherein there is provided a gate handle supported on a top side of the lid body, the gate handle being coupled to the gate member within an interior of the lid body through a slot in the top side of the lid body such that the gate member and the gate handle are moveable together between the open position and the closed position, and wherein the gate handle is moveable relative to the lid body between an open indicator and a closed indicator on the lid body as the gate member is displaced between the open position and the closed position respectively.

10. The lid according to claim 1 wherein the lid body comprises a generally cylindrical outer wall and the gate member comprises an annular member supported along an inner surface of the outer wall about a full circumference of the lid body so as to be moveable between the open and closed positions in a circumferential direction along the inner surface of the outer wall.

11. The lid according to claim 1 in combination with the pitcher wherein the cylindrical wall of the pitcher body includes a lower portion having a first interior diameter and an upper portion above the lower portion having a second interior diameter greater than the first interior diameter, the lid body being received in the upper portion of the pitcher body.

12. The lid according to claim 1 wherein there is provided a stirring mechanism comprising a stir handle supported at a top side of the lid body for rotation about a central upright axis and a mixing blade extending downwardly below the lid member so as to be arranged to extend downwardly into the pitcher body, the stir handle and the mixing blade being coupled for rotation together about the upright axis relative to the lid body, the lid comprising an upper rim portion about a periphery of the lid body and a recessed central portion which is recessed in relation to the surrounding rim portion, the stir handle being located in the recessed central portion and including a gripping portion located radially outward from the upright axis and arranged to be gripped by a user, and wherein the gripping portion is fully received below a height of the rim portion of the lid body.

13. The lid according to claim 1 wherein there is provided a stirring mechanism comprising a stir handle supported on a top side of the lid body and a mixing blade extending below the lid body so as to be arranged to extend into the pitcher body, the stir handle and the mixing blade being coupled together for rotation about a central upright axis relative to the lid body, the stir handle including a gripping portion spaced radially outward from the upright axis in which the gripping portion comprises a socket arranged to receive a single finger of a user therein.

14. The lid according to claim 1 wherein there is provided a stirring mechanism comprising a stir handle supported on a top side of the lid and a mixing blade extending below the lid body so as to be arranged to extend into the pitcher body, the mixing blade and the stir handle being coupled together for rotation together about an upright axis relative to the lid body, and the mixing blade comprising a plate like member which is twisted about the upright axis and which increases in radial distance from the upright axis with increasing distance in an axial direction from the lid body.

15. The lid according to claim 1 in combination with the pitcher wherein the lid body and the pitcher are arranged for interlocking connection so as to be arranged to resist relative rotation about an upright axis therebetween.

16. The lid according to claim 15 wherein the spout protrudes outwardly from the wall of the pitcher body and wherein the lid body comprising a pair of depending portions arranged to extend downwardly along an outer side of the wall of the pitcher body adjacent opposing sides of the spout.

17. The lid according to claim 1 wherein the lid body comprising a cylindrical outer wall and the gate member comprises an annular member spanning a full height of the cylindrical outer wall about a full circumference of the lid body.

18. The lid according to claim 17 wherein the lid body comprises a top wall including a rim portion about a periphery of the lid body and a recessed central portion which is spaced inwardly from the outer wall of the lid body and which is recessed in relation to the rim portion, the gate member comprising a flange portion extending inwardly from a top end of the annular member so as to be arranged to span the rim portion of the lid body in a radial direction between the outer wall and the recessed central portion.

19. The lid according to claim 18 wherein there is provided a gate handle supported on the flange portion of the gate member which extends upwardly through a slot in the rim portion of the lid body.

20. A lid for a pitcher having pitcher body comprising a base, a generally cylindrical wall extending upwardly from the base to a peripheral edge extending about an open top end of the pitcher, the lid comprising:
a lid body arranged to be supported on the pitcher body to span the open top end of the pitcher;
the lid body comprising an upper rim portion about a periphery of the lid body and a recessed central portion which is recessed in relation to the surrounding rim portion;
a stirring mechanism comprising a stir handle supported at a top side of the lid for rotation about a central upright axis and a mixing blade extending downwardly below the lid member so as to be arranged to extend downwardly into the pitcher body;
the stir handle and the mixing blade being coupled for rotation together about the upright axis relative to the lid body;
the stir handle locating a gripping portion therein at a location spaced radially outward from the upright axis;
the gripping portion being arranged to be gripped by a user to rotate the stir handle; and
the gripping portion being fully received below a height of the rim portion of the lid body.
